(19) United States
(12) Patent Application Publication
(10) Pub. No.: US 2003/0070775 A1
(43) Pub. Date: Apr. 17, 2003

(54) Retractable window shades for an automobile

(76) Inventor: Hongbiao Li, Plano, TX (US)

Correspondence Address: Michael L. Diaz, Michael L. Diaz, P.C., Suite 200, 555 Republic Drive, Plano, TX, 75074, US

(21) Appl. No.: 09/974,577

(22) Filed: Oct. 11, 2001

(51) Int. Cl. B60J 3/00

(52) U.S. Cl. 160/370.22; 296/97.8

(57) ABSTRACT

A retractable window shade system for covering a plurality of windows of a vehicle. The window shade system includes a plurality of window shades affixed above the window frames of the vehicle. The window shades are rolled and stored above the window frames of the vehicle when not in use. When desired, pulling one shade also pulls the other shades to the down (extended position). The retractable window shade system may be affixed either on the exterior or the interior of the vehicle.

### BACKGROUND OF THE INVENTION

1. Technical Field of the Invention

This invention relates to window shades and, more particularly, to a plurality of window shades for use within a vehicle.

2. Description of Related Art

In hot climates, it is quite common for vehicles' interiors to become uncomfortably hot. Many times, the interior of a vehicle becomes so hot, that it is painful to touch various parts of the vehicle. In addition, any personal items stowed within the interior of the vehicle are susceptible to damage from excessive heat.

There have been many different devices utilized to reduce the heat within the interior of a vehicle exposed to the sun. One of the more popular items is the use of a cardboard sunshade positioned on the front windshield of the vehicle. This front windshield shade has helped in a limited way in reducing the heat on the front portion of the vehicle. The shade prevents the front dashboard and portions of the front seat from being exposed directly to the sun. However, the front windshield shade suffers from several disadvantages. First, positioning the front windshield shade in the proper position can be difficult. The shade must be expanded from a stored position and positioned under the windscreen mirror. This task may be difficult to accomplish. Second, the shade must be stored within the vehicle when not in use. There is no set position to store the shade, therefore, the shade is stored in various locations within the interior of the vehicle. At times, the shade may be hidden and difficult to find. Other times, the shade may be in the way, such as when the shade is stored on the back seat of the vehicle. If another individual desires to sit in the occupied seat, the shade must be moved. The shade also only prevents exposure of a portion of the interior of the vehicle. The sun can still shine into the other windows of the vehicle, causing the temperature of the vehicle's interior to still rise.

There are no existing devices which provide shade to all the windows of a vehicle, is easy to deploy, and stores in a out of the way location. Thus, it would be a distinct advantage to have an apparatus which shades all the windows of the vehicle, is easily deployed and retracted, and is stored in a designated unobtrusive space. It is an object of the present invention to provide such an apparatus.

### SUMMARY OF THE INVENTION

In one aspect, the present invention is a window shade system for use with a vehicle. The window shade system includes a first sheet of material which may be rolled when retracted and positioned above a first window of the vehicle. The window shade system includes a second sheet of material. The second sheet of material is rolled when retracted and positioned above a second window adjacent the first window of the vehicle. The first and second sheets of material are extended and retracted together. When extended, the first and second sheets of material cover the first and second windows of the vehicle respectively.

In another aspect, the present invention is a window shade system for use within a vehicle. The window shade system includes a first sheet of material. The first sheet of material is rolled when retracted and vertically positioned along a vertical edge of a first window of the vehicle. In addition, a second sheet of material is rolled when retracted and vertically positioned along a vertical edge of a second adjacent window of the vehicle. The first and second sheets of material may be extended and retracted. When extended, the first and second sheets of material cover the first and second windows of the vehicle respectively.

In still another embodiment, the present invention is a window shade system for use on a vehicle. The window shade system includes a first sheet of material which is rolled when retracted and positioned above a first window of the vehicle. The first sheet of material is mounted on an exterior surface of a roof of the vehicle. The system also includes a second sheet of material which is rolled when retracted and positioned above a second window adjacent the first window of the vehicle. The second sheet of material is mounted on the exterior surface of the roof of the vehicle. The first and second sheets of material may be extended and retracted. When extended, the first and second sheets of material cover the first and second windows respectively.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is an interior side view of two left side doors of a vehicle having a rear door window and a front door window in the preferred embodiment of the present invention;

FIG. 2 is a side view of the window shades of FIG. 1 in the extended (down) position in the preferred embodiment of the present invention;

FIG. 3 is a front perspective view of a front windshield having a conventional front vehicle mirror and two front window shades in a retracted position in the preferred embodiment of the present invention;

FIG. 4 is a front perspective view of the front windshield with the front window shades of FIG. 3 in the extended position in the preferred embodiment of the present invention;

FIG. 5 is a front perspective view of the window shade of FIG. 1 separated from the vehicle;

FIG. 6 is a front perspective view of the window shade 10 of FIG. 5 in an extended position;

FIG. 7 is a front perspective view of a front windshield having a conventional front vehicle mirror and a window shade in a retracted position in a first alternate embodiment of the present invention;

FIG. 8 is a front view of the window shade of FIG. 7 in the extended position in the first alternate embodiment of the present invention;

FIG. 9 is a front view of a window shade in a second alternate embodiment of the present invention;

FIG. 10 is a front view of the window shade of FIG. 9 in the retracted view;

FIG. 11 is a front perspective view of the vehicle having a plurality of window shades in a retracted position in the preferred embodiment of the present invention;

FIG. 12 is a front view of the vehicle of FIG. 11 having a plurality 5 of window shades in an extended position in the preferred embodiment of the present invention;

FIG. 13 is a top view of the vehicle illustrating a rotating rod in a third alternate embodiment of the present invention;

FIG. 14 is a partial front perspective view of a portion of the rod illustrating an internal spring and the rolled window shade;

FIG. 15 is a side view of the wire employed as a pulley in a fourth alternate embodiment of the present invention;

FIG. 16 is a front perspective view of the vehicle employing internally mounted shades in a fifth alternate embodiment of the present invention;

FIG. 17 is an interior side view of two left side doors in a sixth alternate embodiment of the present invention;

FIG. 18 is an interior side view of the window shades of FIG. 17 in the extended position;

FIG. 19 is a front perspective view of the vehicle utilizing a plurality of exterior-mounted window shades in a seventh alternate embodiment of the present invention; and

FIG. 20 is a front perspective view of the vehicle utilizing the window shades of FIG. 19 in the extended position.

### DETAILED DESCRIPTION OF EMBODIMENTS

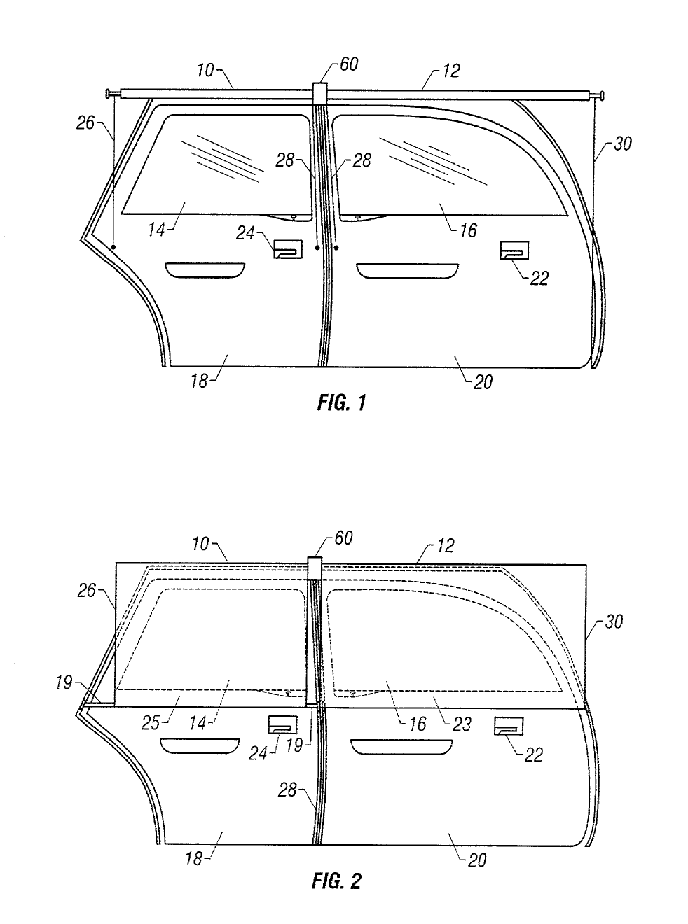

The present invention is retractable window shade system for use on a vehicle. FIG. 1 is an interior side view of two left side doors 18 and 20 of a vehicle 70 having a rear door window 14 and a front door window 16 in the preferred embodiment of the present invention. Each door has a handle 22 and 24. Positioned above the door frame of each door is a window shade 10 and 12. The window shades are retractable rolled sheets of material for use in blocking the sun from the interior of the vehicle. As illustrated in FIG. 1, the window shades are retracted to the rolled (retracted/up) position. The window shades are positioned to be clear of the opening of the doors. The window shades are preferably constructed of a non-transparent flexible material preventing the penetration of sunlight through an extended shade. In an alternate embodiment of the present invention, the window shade may be constructed of a transparent tinted material. However, any flexible material may be utilized, such as fabric, plastic, or any synthetic material. In the preferred embodiment of the present invention, the window shades are similar to retractable window shades utilized in a home, where the shades are pulled downwardly to an extended position to cover the windows. In the retracted position, the shade is rolled back to the up position.

On each side of each window shade and extending horizontally downwardly the full length of the extended window shade may be optionally located wires 26, 28, and 30. The wires guide the shade to the down position. In alternate embodiments of the present invention, any number of wires or other guidance devices may be utilized which provides guidance for extending the window shades.

FIG. 2 is a side view of the window shades 10 and 12 of FIG. 1 in the extended (down) position in the preferred embodiment of the present invention. The window shades are pulled downwardly to the bottom of each vehicle window 14 and 16. Each shade reveals a sheet 23 and 25 to cover the windows. Preferably, the window shades are connected to each other on common sides by connectors 19. The connectors may be constructed of any material, such as wire or fabric. The connectors may also be positioned in any manner to allow the wires to guide the window shades to and from the retracted and extended positions. Therefore, when one window shade is pulled downwardly, the other window shade is also forced downwardly. In an alternate embodiment of the present invention, the window shade may be pulled down by a motor 60 which moves the wire 28 down when actuated. In such an embodiment, a bottom portion of each window shade may be attached to one of the wires (i.e., wire 28). The motor may drive the wire upwardly or downwardly, thus driving the window shades to the extended or retracted position. When the motor is utilized, the wire 28 is preferably affixed to a pulley system (see FIG. 15) to allow the wire to move along a vertical axis. A motorized pulley system is well known to those skilled in the art of mechanized devices. In addition, the motor may be actuated via a remote control unit, preferably associated with remote keying systems well known in vehicle entry devices.

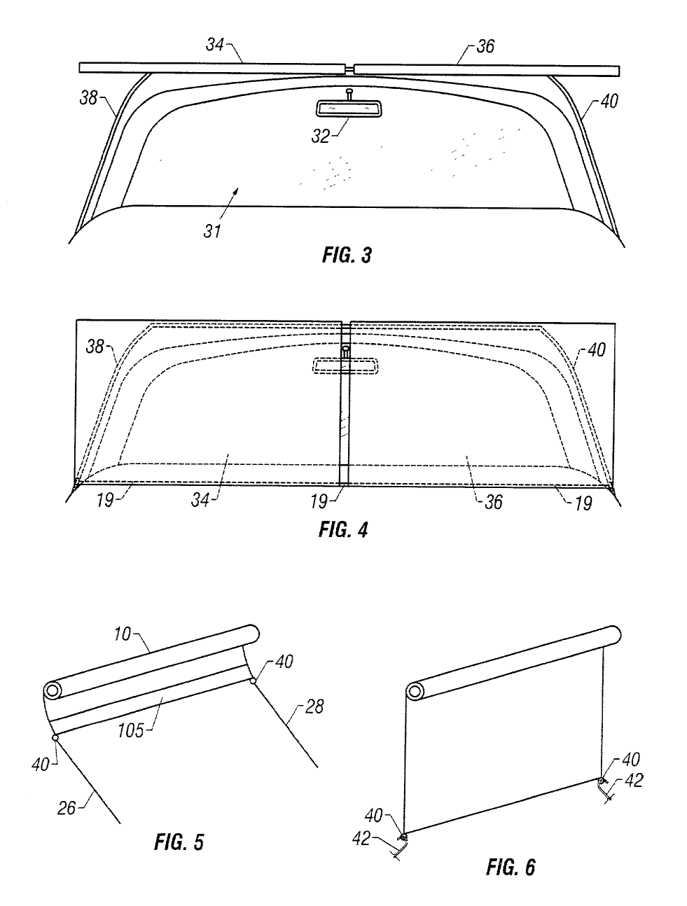

FIG. 3 is a front perspective view of a front windshield 31 having a conventional front vehicle mirror 32 and two front window shades 34 and 36 in a retracted position in the preferred embodiment of the present invention. In a similar fashion as the window shades 10 and 12, the window shades 34 and 36 include wires 38 and 40. The window shades, while in their retracted position, are located above the window frame of the windshield 31, to prevent degradation of forward viewing by the driver through the front windshield.

FIG. 4 is a front perspective view of the front windshield with the front window shades 34 and 36 of FIG. 3 in the extended position in the preferred embodiment of the present invention. The shades are extended downwardly and guided by the wires 38 and 40 in the same manner as described for window shades 10 and 12. The shades may also employ the connector 19 to connect both shades together, allowing the shades to be retracted and extended simultaneously. The connectors may be constructed of any material, such as wire or fabric. The connectors may also be positioned in any manner to allow the wires to guide the window shades to and from the retracted and extended positions.

FIG. 5 is a front perspective view of the window shade 10 of FIG. 1 separated from the vehicle 70. The window shade is illustrated in a partially retracted position. In addition, wires 26 and 28 are illustrated. At a lower portion of the window shade is preferably located loops 40. The wires 26 and 28 run through the loops. In addition, the shade may include a weighted lower edge 105. The shade is preferably weighted at the bottom portion to enable that the window shade remains in a position to completely cover the window of the vehicle. In addition to being weighted, the edge 105 may be constructed of a non-flexible material preventing the shade from bending when in its extended position.

FIG. 6 is a front perspective view of the window shade 10 of FIG. 5 in an extended position. The window shade may be held in an extended position by hooks 42 affixed to the vehicle door. When the shade is extended, the hooks prevent the window shade from moving away from the door window.

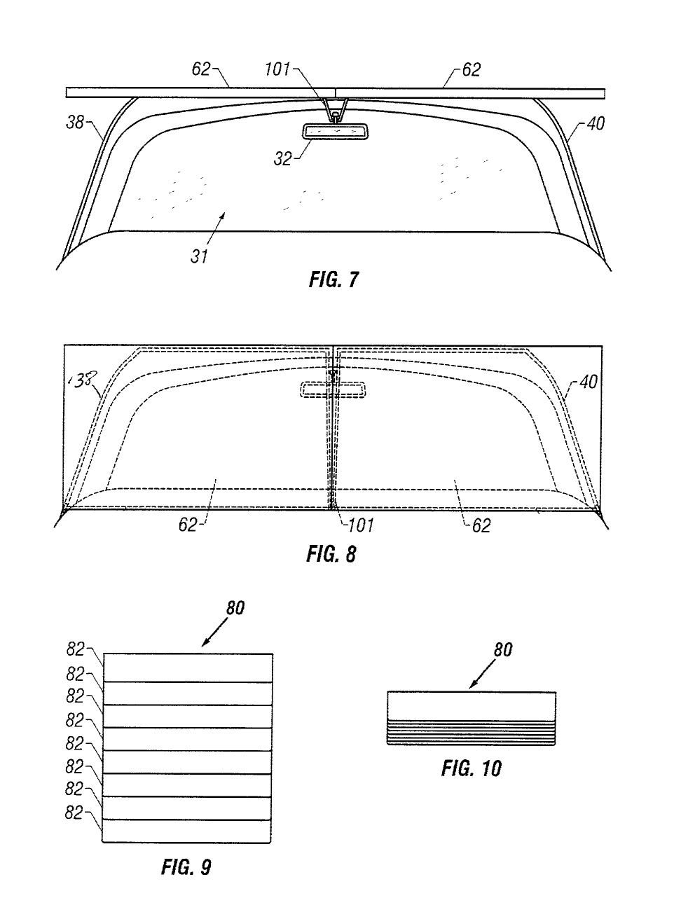

FIG. 7 is a front perspective view of a front windshield 31 having a conventional front vehicle mirror 32 and a window shade 62 in a retracted position in a first alternate embodiment of the present invention. In a similar fashion to the window shades 34 and 36, window shade 62 is affixed to a top portion of the windshield 31 in such a manner as to avoid decreasing the forward visibility of a driver of the vehicle 70. The shade 62 may be one single shade having a divided portion located at the approximate positioned of the mirror. A connecting device 101 may be affixed to each side of the shade at the divided portion of the shade. The connecting device preferably is curved to allow positioning around a lower part of the mirror and includes two expanded legs.

FIG. 8 is a front view of the window shade 62 of FIG. 7 in the extended position in the first alternate embodiment of the present invention. When in the extended position, the shade 62 completely covers the windshield 31. The shade 62 is guided to the proper extended position by the wires 38 and 40. In addition, the shade 62 is preferably attached to the window shade 12 at the window shade 12's front vertical edge. The window shade 62 is also preferably attached to a front right door window shade. Thus, when one shade is extended or retracted, all the shades are moved. The window shade 62 may also include a weighted lower edge or hooks 42 affixed to the front windshield (not shown). As the window shade is extended, the legs of connecting device are biased inwardly, which forces the window shade edges adjacent to the gap located at the mirror of the window shade to come together. Thus, the surface area of the gap of the window shade is reduced or eliminated.

FIG. 9 is a front view of a window shade 80 in a second alternate embodiment of the present invention. The window shade 80 includes a plurality of segments 82 which may be collapsed in a compact area. FIG. 9 illustrates the shade 80 in the extended position. FIG. 10 is a front view of the window shade 80 of FIG. 9 in the retracted view. When in the retracted position, the window shade may be compacted by overlaying each segment 82 over an adjacent segment, thereby compacting the window shade into a small area.

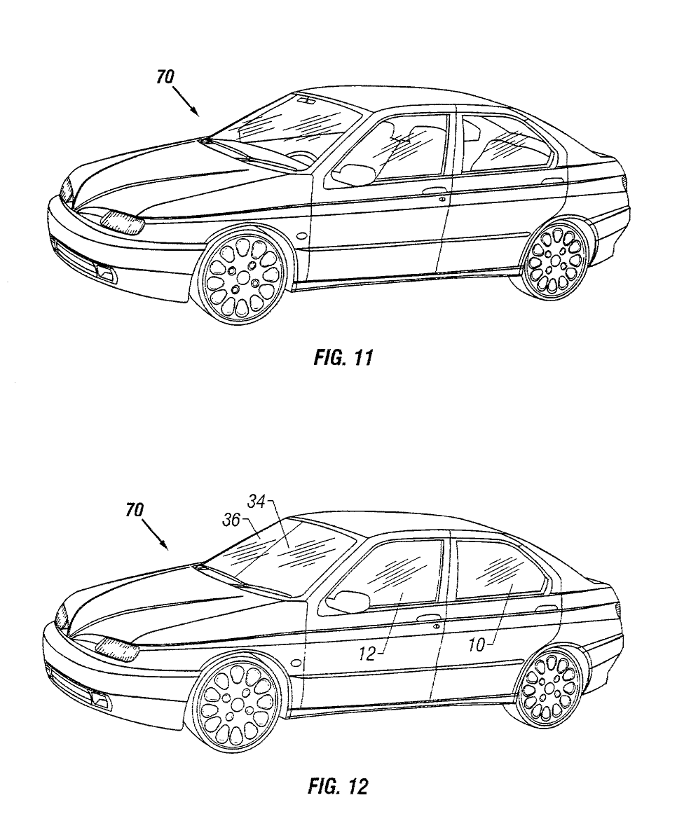

FIG. 11 is a front perspective view of the vehicle 70 having a plurality of window shades in a retracted position in the preferred embodiment of the present invention. The window shades, while in the retracted position, are mounted on the interior of the vehicle in such a fashion as to allow full view through the vehicle's windows.

FIG. 12 is a front view of the vehicle 70 of FIG. 11 having a plurality of window shades in an extended position in the preferred embodiment of the present invention. As illustrated, the shades 10, 12, 34, and 36 are extended to cover the vehicle windows. Although it is not shown, the right door and rear windows may also include window shades affixed and deployed in the same manner as the window shades 10, 12, 34, and 36. With the window shades in the extended position, the sun's rays are prevented from entering the interior of the vehicle, thereby keeping the interior cooler and preventing damage caused by the sun.

The operation of the plurality of window shades described above will now be explained. Normally, when operating the vehicle, the window shades are in the retracted position. Since the window shades are preferably affixed to the top of the door or window frame of the vehicle, the window shades do not obscure the vision of the occupants of the vehicle. When exiting the vehicle, any occupant of the vehicle may deploy the window shades. As discussed above, the window shades are all connected on adjacent edges with each other. Thus, when an occupant of the vehicle pulls one window shade downwardly, all the window shades follow. For ease of exit from the vehicle, the occupants should leave the vehicle prior to deployment of the window shades. The window shades may be held down through a hook or hooks 42. In the preferred embodiment of the present invention, the extension, as well as the retraction of the shades may be motorized by connecting the motor to one of the wires. The wire may be employed as a pulley to move one window shade downwardly. Since all the window shades are interconnected, all the window shades are pulled to the extended position. In addition, the window shades may be retracted or extended by a remote control.

When the occupant wishes to enter the vehicle, the window shades are retracted. The window shades may be released from the hooks 42 and initially pulled downwardly and released, allowing the window shades to retract to the retracted position, in a similar fashion as conventional retractable window shades common in many homes. Alternatively, the motor 60 may be employed to drive one window shade upwardly by one of the wires guiding the window shades, thereby pulling the connected plurality of window shapes upwardly.

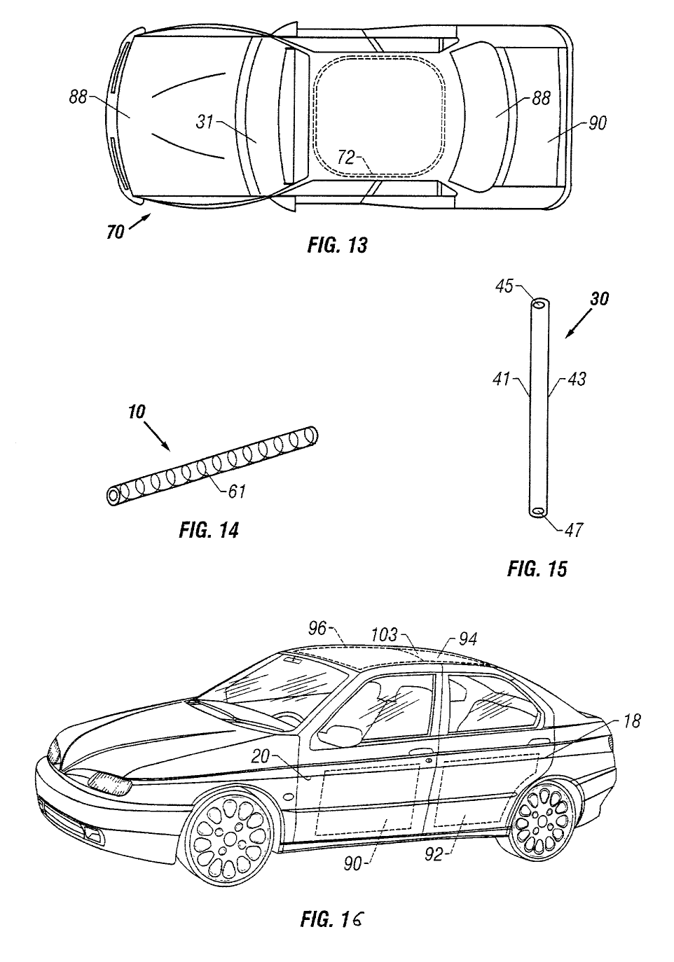

FIG. 13 is a top view of the vehicle 70 illustrating a rotating rod 72 in a third alternate embodiment of the present invention. The rod 72 may be employed for extending and retracting the plurality of window shades. The rod is positioned at the intersection of the ceiling of the vehicle and the upper portion of the window/door frame. The rod extends completely around the perimeter of the ceiling of the vehicle, curving around the edges of the vehicle corners. The rod is affixed in such a manner to allow the rod to rotate. The window shades are rolled onto the rod. Rotation of the rod allows the entire length of the rod and the attached window shades to rotate. By extending one of the window shades, all connected window shades, which are also rolled about the rod, are also extended downward. The rod is allowed to rotate to provide the unrolling of each window shade. When retracting the window shade, the rod may be rotated in the opposite direction to roll each window shade back into its retracted position. The rod may employ a spring release mechanism allowing the retraction of the plurality of window shades. Alternatively, the rod may be similar to the conventional retractable window shades of a home by employing a release/spring tension mechanism to retract and extend the window shades.

FIG. 14 is a partial front perspective view of a portion of the rod 72 illustrating an internal spring 61 and the rolled window shade 10. The spring 61 may be coiled within the interior of the window shade to allow the rod 61 to be spun in one direction, locked, and when desired released, causing the rod to spin in the opposite direction.

FIG. 15 is a side view of the wire 30 employed as a pulley in a fourth alternate embodiment of the present invention. As discussed above, the wire 30 may be employed in a pulley system to drive a window shade up or down. The wire is attached to an upper pulley 45 and a lower pulley 47. The wire 30 is allowed to rotate around the two pulleys, thus moving the wire in one direction on side 43 and moving the wire in the opposite direction on the other side 41.

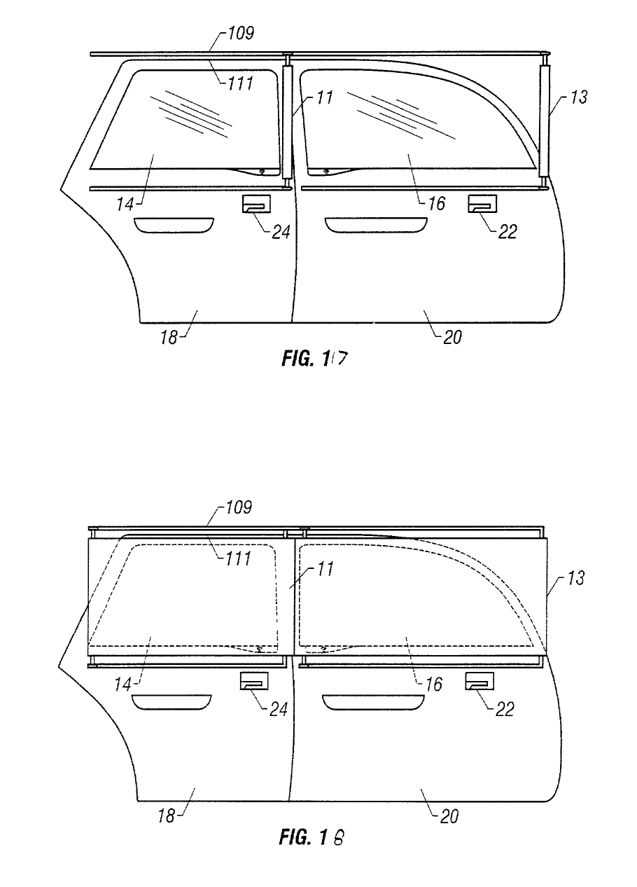

FIG. 16 is a front perspective view of the vehicle 70 employing internally mounted shades in a fifth alternate embodiment of the present invention. Rather than mounting the window shades on a top interior portion of the vehicle, the window shades may be positioned within an interior portion of the plurality of doors and roof. For example a window shade 90 located in which the interior of the front door 20 may be utilized. As illustrated, a separate window shade from each wind is used to block or decrease entry of the sun's rays into the interior of the vehicle. In a similar manner as windows located on each vehicle door, a window shade 92 is mounted within an interior portion of the door 18. The window shades 90 and 92, as well as their corresponding opposite window shades located on the right doors, are mounted in a similar manner as the conventional windows of the door. When the windows are retracted, the windows are moved down within the interior of the door. As with conventional door vehicle windows, the window shades 90 and 92 operate in a similar fashion. In addition, the window shades 90 and 92 move up and down either in conjunction or separately, actuated within the door windows. In addition, window shade 96 may be mounted within the roof of the vehicle, preferably interiorly mounted. When extended, the shade 96 is driven forward and slides downwardly to cover the front windshield. 31. In addition, the window shade 94 slides back to cover the rear window of the vehicle. The window shades stored within the roof of the vehicle operate in a similar fashion as seen in many conventional sun roofs.

FIG. 17 is an interior side view of two left side doors 18 and 20 in a sixth alternate embodiment of the present invention. Window shades 11 and 13 may be attached in a vertical orientation at one vertical edge of each window. FIG. 17 illustrates the window shades 11 and 13 in the retracted (closed) position. The window shades 11 and 13 include a common wire 109 horizontally positioned above both windows 14 and 16. In addition, each window shade includes a horizontally positioned wire 121 and 123. The bottom wires are not attached to each other because it would not be possible to open either side vehicle door.

FIG. 18 is an interior side view of the window shades 11 and 13 of FIG. 17 in the extended position. The window shades 11 and 13 are similar to the horizontally mounted window shades 10 and 12 of FIG. 1, with the exception of being mounted vertically. The window shades 11 and 13 extend horizontally to cover each window. The window shades may be held in the extended position by hooks (not shown in FIG. 18) or other attachment devices as described for the window shades 10 and 12.

With reference to FIGS. 17 and 18, the operation of the window shades 11 and 13 will now the explained. One of the window shades is pulled horizontally backwards, thereby unrolling the window shade. The adjacent window shade also is unrolled because the wire 109 is connected to the adjacent window shade. Specifically, the wire 109 may be attached to each window shade within the vehicle. The wire may be positioned completely around a perimeter of the vehicle, above each window. Pulling one window shade moves the wire in one direction. The other window shades, attached to the wire 109 are also pulled by the moving wire in the same direction, in this example, to the extended position. When the window shades are desired to be retracted, the operator retracts one window shade, which closes the other window shades. The window shades may retract in a similar fashion as retractable window shades found in homes.

Although not depicted, the front and rear windows may also operate in a similar manner. Due to the length of the front and rear windows, the front and rear window shades may each employ a plurality of window shades to cover each window. For example, a window shade may cover the left portion of the front window and another window shade may cover the right portion of the front window. In addition, through a pulley or gear system, each window shade may be driven in opposite directions. Such a split window shade assembly is particular effective for use on front and rear windows.

Although a wire 109 has been described, any material or device may be used which allows the movement of all the window shades when moving one window shade. Also, in a similar manner as the window shades 10 and 12 of FIG. 1, the window shades 11 and 13 may use a motor to drive the window shades open and closed. In addition, the window shades may be segmented window shades as illustrated in FIG. 9.

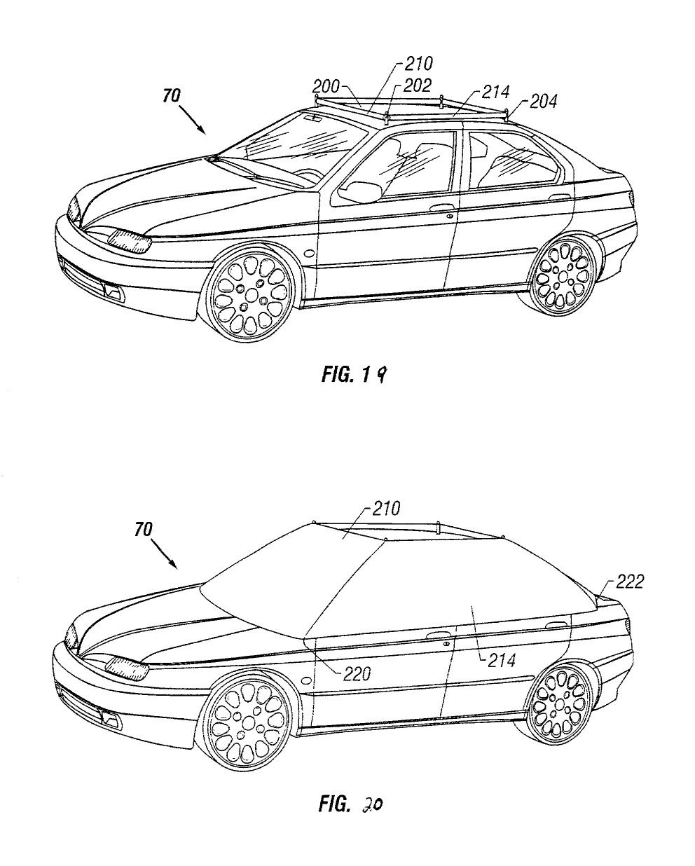

FIG. 19 is a front perspective view of the vehicle 70 utilizing a plurality of exterior-mounted window shades 210 and 214 in a seventh alternate embodiment of the present invention. The window shades 210 and 214 are mounted upon the roof of the vehicle 70. Preferably, the window shades are mounted slightly above the roof on station points (202 and 204 are illustrated). FIG. 19 illustrates the shades in the retracted position. The window shades may be mounted on a rod such as that illustrated in FIG. 13 (rod 72). However, the rod is located on the exterior of the vehicle.

FIG. 20 is a front perspective view of the vehicle 70 utilizing the window shades 210 and 214 of FIG. 19 in the extended position. The window shades are pulled downwardly and held in position by hooks or other connecting mechanisms explained in FIG. 1. The hooks may be used as attachment devices by affixing the hooks to the car at a position where the window shades lie in the extended position. Although window shades 210 and 214 are illustrated, it should be understood that all the windows are covered by window shades. In addition, the window shades are preferably constructed of a durable, elastic material preventing sunshine from entering the interior of the vehicle. However, in alternate embodiments of the present invention, the window shades may be constructed of any durable material. In addition, although the window shades in FIGS. 19 and 20 are depicted as being located near the perimeter of the roof, the window shades may be mounted anywhere on the top portion of the vehicle.

With reference to FIGS. 19 and 20, the operation of the window shades 210 and 214 will now the explained. The window shades are stored in the retracted positioned illustrated in FIG. 19. The window shades are preferably rolled in the same manner as the window shade 10 of FIG. 1. The window shades 210 and 214 are positioned slightly above the roof of the vehicle to provide adequate room for the window shades to be deployed.

When the operator desires to cover the windows, one window shade may be pulled downwardly. Each window shade is connected to an adjacent window shade by connectors 220 and 222. Pulling one window shades also provides a downward force for each adjacent window shade. When the window shades cover the windows of the vehicle, the window shades are held in position by attachment means, such as hooks located near the bottom of the extended window shades (not shown).

When the operator desires to open the window shades, the operator momentarily pulls downwardly and then releases the window shades, causing the window shades to retract to its rolled retracted position, in a similar manner as window shades located within houses. A motor may be employed to automate the movement of the window shades.

The window shades of the present invention provide many advantages over existing devices used to cover windows. The window shades may cover all or some of the windows of the vehicle. In existing window shades, merely the front window shield is covered. With the use of retractable window shades, the covering of the windows is a much simpler and faster operation. In alternate embodiments of the present invention, the window shades may utilize a motor to provide an even more convenient method of actuating the window shades. In addition, when in its retracted position, the shade is stored in an unobtrusive position.

It is thus believed that the operation and construction of the present invention will be apparent from the foregoing description. While the apparatus shown and described has been characterized as being preferred, it will be readily apparent that various changes and modifications could be made therein without departing from the scope of the invention as defined in the following claims.

What is claimed is:

1. A window shade system for use on a vehicle, the window shade system comprising:
a first sheet of material, said first sheet of material being rolled when retracted and positioned above a first window of the vehicle;
a second sheet of material, said second sheet of material being rolled when retracted and positioned above a second window adjacent the first window of the vehicle; and
means for extending and retracting said first sheet of material and said second sheet of material;
whereby said first sheet of material covers said first window and said second sheet of material covers said second sheet of material when extended.

2. The window shade system of claim 1 wherein said means for extending and retracting said first sheet of material and said second sheet of material includes connecting said first sheet of material to said second sheet of material, whereby pulling said first sheet of material simultaneously pulls said second sheet of material down.

3. The window shade system of claim 2 wherein said means for extending and retracting said first sheet of material and said second sheet of material includes means for holding said first sheet of material and said second sheet of material in an extended position, the extended position allowing said first sheet of material to cover the first window and said second sheet of material to cover the second window.

4. The window shade system of claim 1 wherein said first sheet of material and said second sheet of material are constructed of a tinted material.

5. The window shade system of claim 1 further comprising a third sheet of material covering a front windshield of the vehicle, said third sheet of material curved around a stem of a mirror affixed to the front window shield.

6. The window shade system of claim 5 wherein the third sheet of material includes a split to accommodate the stem of the mirror when said third sheet of material is in a retracted position.

7. The window shade system of claim 1 wherein said means for extending and retracting said first sheet of material and said second sheet of material includes a motor for driving said first sheet and said second sheet of material to an extended and a retracted position.

8. The window shade system of claim 1 wherein said first sheet of material and said second sheet of material are positioned on an exterior side of a roof of the vehicle.

9. The window shade system of claim 1 further comprising at a plurality of window shades to cover all windows of the vehicle.

10. A window shade system for use on a vehicle, the window shade system comprising:
a first sheet of material, said first sheet of material being rolled when retracted and vertically positioned along a vertical edge of a first window of the vehicle;
a second sheet of material, said second sheet of material being rolled when retracted and vertically positioned along a vertical edge of a second adjacent window of the vehicle;
means for horizontally extending and retracting said first sheet of material and said second sheet of material;
whereby said first sheet of material covers the first window and said second sheet of material covers the second window when extended.

11. The window shade system of claim 10 wherein said means for horizontally extending and retracting said first sheet of material and said second sheet of material includes connecting the first sheet of material to said second sheet of material, whereby pulling said first sheet of material simultaneously pulls the second sheet of material to an extended position.

12. The window shade system of claim 10 wherein said means for extending and retracting said first sheet of material and said second sheet of material includes means for holding said first sheet of material and said second sheet of material in an extended position, the extended position allowing the first sheet of material to cover the first window and said second sheet of material to cover the second window.

13. The window shade system of claim 10 wherein said first sheet of material and said second sheet of material are constructed of a tinted material.

14. The window shade system of claim 10 farther comprising:
a third sheet of material covering a left portion of a front windshield of the vehicle, said third sheet of material being position on a left outer vertical edge of the front windshield;
a fourth sheet of material covering a right portion of the front windshield, said fourth sheet of material being positioned on a right outer vertical edge of the front windshield; and
means for retracting and extending said third and fourth sheets of material simultaneously with said first and second sheets of material.

15. The window shade system of claim 10 wherein said means for extending and retracting said first sheet of material and said second sheet of material includes a motor for driving said first sheet and said second sheet of material to an extended and a retracted position.

16. The window shade system of claim 10 wherein said first sheet of material and said second sheet of material are positioned on an exterior side of a roof of the vehicle.

17. The window shade system of claim 10 further comprising a plurality of window shades to cover all the windows of the vehicle.

18. A window shade system for use on a vehicle, the window shade system comprising:
a first sheet of material, said first sheet of material being rolled when retracted and positioned above a first window of the vehicle, said first sheet of material being mounted on an exterior surface of a roof of the vehicle;
a second sheet of material, said second sheet of material being rolled when retracted and positioned above a second window adjacent the first window of the vehicle, said second sheet of material being mounted on the exterior surface of the roof of the vehicle;
means for extending and retracting said first sheet of material and said second sheet of material;
whereby said first sheet of material covers the first window and said second sheet of material covers the second window when extended.

19. The window shade system of claim 18 wherein the first sheet of material is connected to the second sheet of material and whereby pulling said first sheet of material correspondingly pulls the second sheet of material down.

20. The window shade system of claim 19 further comprising means for holding the first and second sheets of material in an extended position to cover the first and second windows of the vehicle.
